(19) United States
(12) Patent Application Publication
(10) Pub. No.: US 2025/0172430 A1
(43) Pub. Date: May 29, 2025

(54) LIFT OFF SPEED DETECTION

(71) Applicant: Garrett Transportation I Inc., Torrance, CA (US)

(72) Inventors: Radu Florea, Yorba Linda, CA (US); Frederic Daguin, Charmes (FR)

(73) Assignee: Garrett Transportation I Inc., Torrance, CA (US)

(21) Appl. No.: 18/522,331

(22) Filed: Nov. 29, 2023

(51) Int. Cl. G01H 1/00; F04D 25/06; F04D 27/00

(52) U.S. Cl. CPC G01H 1/006; F04D 25/066; F04D 27/001; F04D 27/004; F05D 2220/40; F05D 2260/80

(57) ABSTRACT

A compressor having a rotational shaft supported by a plurality of air foil bearings, a frequency sensor for detecting a frequency of a signal emitted by the device during rotation of the rotational shaft, a controller for detecting a lift off speed of the plurality of air foil bearings in response to the frequency of the signal, and a memory for storing the lift off speed, wherein the memory is communicatively coupled to a device controller for controlling a rotational speed of the rotational shaft in response to the lift off speed wherein the detection of the lift off speed is made in response to a sudden change in the frequency of the signal emitted by the device during a coast down of the compressor from a maximum rotational speed to a zero rotational speed.

### TECHNICAL FIELD

The present disclosure generally relates to a test system for determining a lift off speed for a compressor with foil bearings, and more particularly, relates to determining a lift off speed of an air foil bearing in response to a frequency and amplitude of a vibration to the compressor and a rotational speed measured at a plurality of times during a transition of the rotational speed between a maximum rotational speed and a zero rotational speed.

### BACKGROUND

A foil bearing, also known as an air foil bearing (AFB), is a type of bearing that uses a spring loaded foil journal lining to support a rotating shaft. The foil is separated from the shaft by a thin layer of air or liquid. The pressure from the thin layer of air or liquid holds the moving and stationary surfaces apart, allowing low-friction, high-speed rotation. Foil bearings, such as AFBs, are commonly used in turbomachinery applications, such as gas turbines, compressors, and blowers. Air foil bearings can operate at very high speeds, making them ideal for turbomachinery applications. AFBs also have very low friction, which can lead to significant energy savings.

AFBs are self-starting, meaning that they do not require an external pressurization system for the working fluid. AFBs use a compliant, spring-loaded foil journal lining to support the shaft. Once the shaft is spinning fast enough, the AFB reaches a lift off speed (LOS) when the air pushes the foil away from the shaft so that no contact occurs. The shaft and foil are separated by the air's high pressure, which is generated by the rotation that pulls gas into the bearing via viscosity effects. The high speed of the shaft with respect to the foil is required to initiate the air gap, and once this has been achieved, no wear occurs. Below the lift-off speed, the bearing will operate in boundary or mixed lubrication conditions, which can lead to increased friction and wear. AFBs need to be quality tested prior to shipping by determining the LOS for each AFB to ensure proper operation of the bearing, to ensure that the AFBs meet design and performance specifications and for regulatory compliance purposes.

. There are a number of ways to determine the lift-off speed of an air foil bearing. One common method is to measure the bearing's friction torque as the speed is increased or decreased. The lift-off speed is typically defined as the speed at which the friction torque begins to decrease or by using computational fluid dynamics (CFD) modeling. CFD modeling can be used to simulate the flow of air through the bearing and to predict the lift-off speed. These LOS tests can be time consuming and difficult to implement in a production setting. It would be desirable to incorporate a test that can detect bearing quality issues prior to shipping a completed product including the AFBs, such as a compressor, fuel cell compressor or air conditioning compressor on the production assembly line. Other desirable features and characteristics of the present disclosure will become apparent from the subsequent detailed description and the appended claims, taken in conjunction with the accompanying drawings and this background discussion.

The above information disclosed in this background section is only for enhancement of understanding of the background of the invention and therefore it may contain information that does not form the prior art that is already known in this country to a person of ordinary skill in the art.

### BRIEF SUMMARY

In one embodiment, a system for determining a lift off speed of an AFB incorporated into a compressor including a device having a rotational shaft supported by a plurality of air foil bearings, a sensor for detecting a frequency and amplitude of a signal emitted by the device during rotation of the rotational shaft, a controller for detecting a lift off speed of the plurality of air foil bearings in response to the frequency and amplitude of the signal, and a memory for storing the lift off speed, wherein the memory is communicatively coupled to a device controller for controlling a rotational speed of the rotational shaft in response to the lift off speed.

In another embodiment, a method for determining a lift off speed of an air foil bearing incorporated into a compressor including controlling a device having a rotational shaft supported by a plurality of air foil bearings to rotate at a predetermined operational rotational speed, disengaging a drive source coupled to the rotational shaft such that the rotational shaft begins a rotational speed coast down phase from the maximum operational rotational speed to a zero rotational speed, detecting, by a frequency sensor, a frequency of a vibration of the device and a rotational speed of the rotational shaft at a plurality of times within the coast down phase, determining, by a test controller, a lift off speed of the air foil bearing in response to the plurality of frequencies, and storing the lift off speed in a memory communicatively coupled to the device.

Moreover, A compressor test system including a controller for determining a rotational speed of a compressor shaft supported by an air foil bearing, a sensor, such as an accelerometer or an inertial measurement unit, for measuring a frequency of a vibration generated in response to a rotation of the compressor shaft, a controller for determining a lift off speed of the air foil bearing in response to the frequency of the vibration and the rotational speed measured at a plurality of times during an transition of the rotational speed between a zero rotational speed and a predetermined rotational speed, and a compressor controller for controlling an operation of the compressor such that an operating rotational speed of the compressor shaft is greater than the lift off speed.

The above advantage and other advantages and features of the present disclosure will be apparent from the following detailed description of the preferred embodiments when taken in connection with the accompanying drawings.

### BRIEF DESCRIPTION OF THE DRAWINGS

The present disclosure will hereinafter be described in conjunction with the following drawing figures, wherein like numerals denote like elements, and wherein:

FIG. 1 illustrates an exemplary compressor configuration according to exemplary embodiments of the present disclosure;

FIG. 2 illustrates an exemplary system for regulating a compressor rotational speed according to an exemplary embodiments of the present disclosure;

FIG. 3 illustrates an exemplary method for regulating a compressor rotational speed according to an exemplary embodiments of the present disclosure;

FIG. 4 illustrates another exemplary system for regulating a compressor rotational speed according to an exemplary embodiments of the present disclosure; and

FIG. 5 illustrates another exemplary method for regulating a compressor rotational speed according to an exemplary embodiments of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

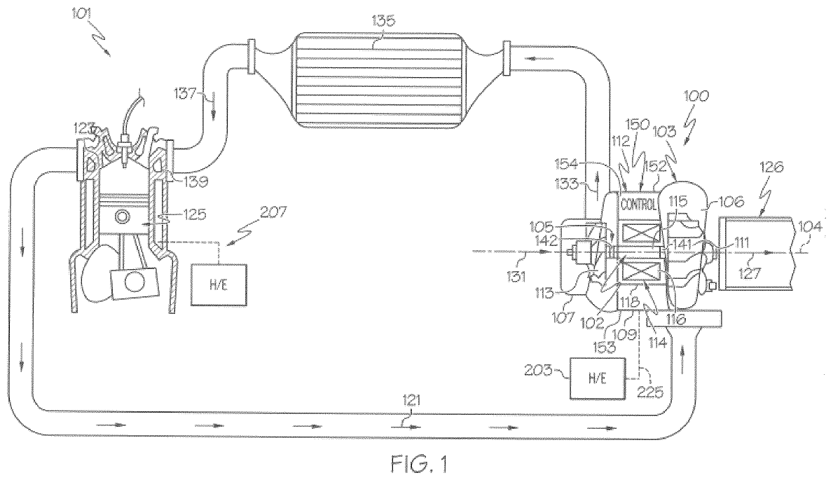

FIG. 1 is a schematic view of an example turbomachine, such as a compressor 100 that is incorporated within an engine system 101 and that includes one or more features of the present disclosure. It will be appreciated that the compressor 100 could be another turbomachine (e.g., a supercharger, a turbine-less compressor device, etc.) in additional embodiments of the present disclosure. Furthermore, the turbomachine of the present disclosure may be incorporated into a number of systems other than an engine system without departing from the scope of the present disclosure. For example, the turbomachine of the present disclosure may be incorporated within a fuel cell system for compressing air that is fed to a fuel cell stack, or the turbomachine may be incorporated within another system without departing from the scope of the present disclosure.

Generally, the compressor 100 may include a housing 103 and a rotating group 102, which is supported within the housing 103 for rotation about an axis 104 by a bearing system 105. The bearing system 105 may be of any suitable type, such as a roller-element bearing or an air bearing system. As shown in the illustrated embodiment, the housing 103 may include a turbine housing 106, a compressor housing 107, and an intermediate housing 109. The intermediate housing 109 may be disposed axially between the turbine and compressor housings 106, 107.

Additionally, the rotating group 102 may include a turbine wheel 111, a compressor wheel 113, and a shaft 115. The turbine wheel 111 is located substantially within the turbine housing 106. The compressor wheel 113 is located substantially within the compressor housing 107. The shaft 115 extends along the axis of rotation 104, through the intermediate housing 109, to connect the turbine wheel 111 to the compressor wheel 113. Accordingly, the turbine wheel 111 and the compressor wheel 113 may rotate together as a unit about the axis 104.

The turbine housing 106 and the turbine wheel 111 cooperate to form a turbine stage (i.e., turbine section) configured to circumferentially receive a high-pressure and high-temperature exhaust gas stream 121 from an engine, specifically, from an exhaust manifold 123 of an internal combustion engine 125. The turbine wheel 111 and, thus, the other components of the rotating group 102 are driven in rotation around the axis 104 by the high-pressure and high-temperature exhaust gas stream 121, which becomes a lower-pressure and lower-temperature exhaust gas stream 127 that is released into a downstream exhaust pipe 126.

The compressor housing 107 and compressor wheel 113 form a compressor stage (i.e., compressor section). The compressor wheel 113, being driven in rotation by the exhaust-gas driven turbine wheel 111, is configured to compress received input air 131 (e.g., ambient air, or already-pressurized air from a previous-stage in a multi-stage compressor) into a pressurized airstream 133 that is ejected circumferentially from the compressor housing 107. The compressor housing 107 may have a shape (e.g., a volute shape or otherwise) configured to direct and pressurize the air blown from the compressor wheel 113. Due to the compression process, the pressurized air stream is characterized by an increased temperature, over that of the input air 131.

The pressurized airstream 133 may be channeled through an air cooler 135 (i.e., intercooler), such as a convectively cooled charge air cooler. The air cooler 135 may be configured to dissipate heat from the pressurized airstream 133, increasing its density. The resulting cooled and pressurized output air stream 137 is channeled into an intake manifold 139 of the internal combustion engine 125, or alternatively, into a subsequent-stage, in-series compressor.

Furthermore, the compressor 100 may include an e-machine stage 112. The e-machine stage 112 may be cooperatively defined by the intermediate housing 109 and by an e-machine 114 housed therein. The shaft 115 may extend through the e-machine stage 112, and the e-machine 114 may be operably coupled thereto. The e-machine 114 may be an electric motor, an electric generator, or a combination of both. Thus, the e-machine 114 may be configured as a motor to convert electrical energy to mechanical (rotational) energy of the shaft 115 for driving the rotating group 102. Furthermore, the e-machine 114 may be configured as a generator to convert mechanical energy of the shaft 115 to electrical energy that is stored in a battery, etc. As stated, the e-machine 114 may be configured as a combination motor/generator, and the e-machine 114 may be configured to switch functionality between motor and generator modes in some embodiments as well.

For purposes of discussion, the e-machine 114 will be referred to as a motor 116. The motor 116 may include a rotor member (e.g., a plurality of permanent magnets) that are supported on the shaft 115 so as to rotate with the rotating group 102. The motor 116 may also include a stator member (e.g., a plurality of windings, etc.) that is housed and supported within the intermediate housing 109. In some embodiments, the motor 116 may be disposed axially between a first bearing 141 and a second bearing 142 of the bearing system 105. Also, the motor 116 may be housed by a motor housing 118 of the intermediate housing 109. The motor housing 118 may be a thin-walled or shell-like housing that encases the stator member of the motor 116. The motor housing 118 may also encircle the axis 104, and the shaft 115 may extend therethrough.

Furthermore, the compressor 100 may include an integrated controller 150. The integrated controller 150 may generally include a controller housing 152 and a number of internal components 154 (e.g., circuitry, electronic components, cooling components, support structures, etc.) housed within the controller housing 152. The integrated controller 150 may control various functions. For example, the integrated controller 150 may control the motor 116 to thereby control certain parameters (torque, angular speed, START/STOP, acceleration, etc.) of the rotating group 102. The integrated controller 150 may also be in communication with a battery, an electrical control unit (ECU), or other components of the respective vehicle in some embodiments. More specifically, the integrated controller 150 may receive DC power from a vehicle battery, and the integrated controller 150 may convert the power to AC power for controlling the motor 116. In additional embodiments wherein the e-machine 114 is a combination motor/generator, the integrated controller 150 may operate to switch the e-machine 114 between its motor and generator functionality.

In some embodiments, the integrated controller 150 may be disposed axially between the compressor stage and the turbine stage of the compressor 100 with respect to the axis 104. Thus, as illustrated, the integrated controller 150 may be disposed and may be integrated proximate the motor 116. For example, as shown in the illustrated embodiment, the integrated controller 150 may be disposed on and may be arranged radially over the motor housing 118. More specifically, the integrated controller 150 may extend and wrap about the axis 104 to cover over the motor 116 such that the motor 116 is disposed radially between the shaft 115 and the integrated controller 150. The integrated controller 150 may also extend about the axis 104 in the circumferential direction and may cover over, overlap, and wrap over at least part of the motor housing 118. In some embodiments, the integrated controller 150 may wrap between approximately forty-five degrees) (45°) and three-hundred-sixty-five degrees) (365°) about the axis 104.

As illustrated, the housing 152 may generally be arcuate so as to extend about the axis 104 and to conform generally to the rounded profile of the compressor 100. The housing 152 may also be an outer shell-like member that is hollow and that encapsulates the internal components 154. Electrical connectors may extend through the housing 152 for electrically connecting the internal components 154. Furthermore, there may be openings for fluid couplings (e.g., couplings for fluid coolant). Additionally, the controller housing 152 may define part of the exterior of the compressor 100. An outer surface 153 of the controller housing 152 may extend about the axis 104 and may face radially away from the axis 104. The outer surface 153 may be at least partly smoothly contoured about the axis 102 as shown, or the outer surface 153 may include one or more flat panels that are arranged tangentially with respect to the axis 104 (e.g., a series such flat panels that are arranged about the axis 104). The outer surface 153 may be disposed generally at the same radius as the neighboring compressor housing 107 and/or turbine housing 106. Accordingly, the overall size and profile of the compressor 100, including the controller 150, may be very compact.

The internal components 154 may be housed within the controller housing 152. Also, at least some of the internal components 154 may extend arcuately, wrap about, and/or may be arranged about the axis 104 as will be discussed. Furthermore, as will be discussed, the internal components 154 may be stacked axially along the axis 104 in close proximity such that the controller 150 is very compact. As such, the integrated controller 150 may be compactly arranged and integrated with the turbine stage, the compressor stage, and/or other components of the compressor 100. Also, internal components 154 of the controller 150 may be in close proximity to the motor 116 to provide certain advantages. For example, because of this close proximity, there may be reduced noise for more efficient control of the motor 116.

Furthermore, the controller 150 may include a number of components that provide robust support and that provide efficient cooling. Thus, the compressor 100 may operate at extreme conditions due to elevated temperatures, mechanical loads, electrical loads, etc. Regardless, the controller 150 may be tightly integrated into the compressor 100 without compromising performance.

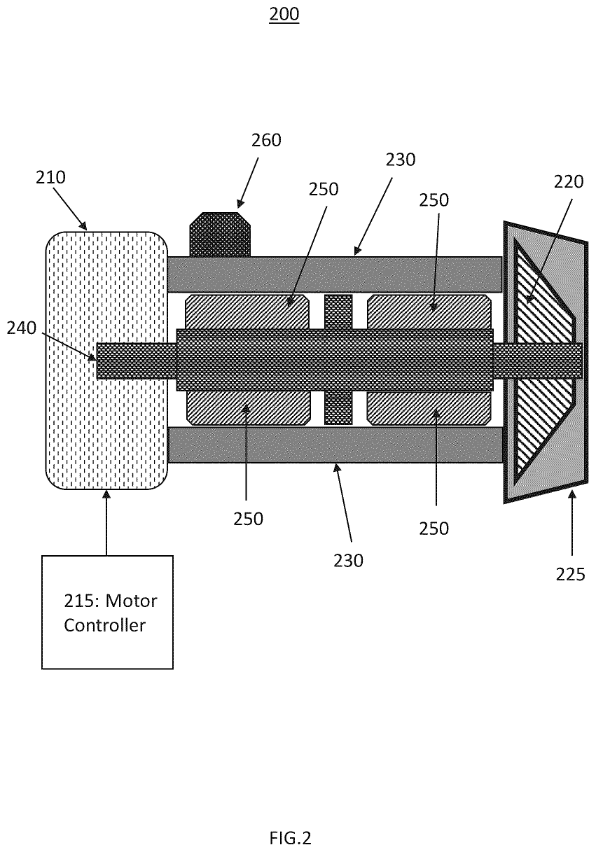

Referring now to FIG. 2, an compressor test system 200 for determining an AFB lift off speed in a compressor according to an exemplary embodiment of the present disclosure is shown. The exemplary system 200 can include an electric motor 210, motor controller 215, impeller 220, impeller housing 225, compressor housing 230, shaft 240, AFBs 250 and a sensor 260. The exemplary test system 200 is illustrative of a test configuration, such as is installed in a production environment, used to detect a bearing LOS installed in a centrifugal compressor by detecting a change in the frequency spectrum of shaft motion probes and or acceleration of the compressor housing 230. A centrifugal compressor is a device that uses the electric motor 210, or in some cases the exhaust gas from an engine, to rotate the shaft 240 to drive the impeller 220. The impeller 220 compresses outside air and forces this compressed air back into an engine or a cooling system.

The electric motor 210 converts electrical energy to generate magnetic fields within one or more coils of wire, known as a rotor, to apply a magnetic force on one or more stationary permanent magnets within a stator. This rotational motion is transferred to a common shaft 240 that connects the turbine wheel to the impeller 220. A motor controller 215 can be used to control the rotational speed of the electric motor 210 and, in some exemplary embodiments, may convert a direct current (DC) to an alternating current (AC) using inverter circuitry to supply the AC current to the rotor of the electric motor 210. The switching rate of the inverter circuitry can be used to control the rotational speed of the electric motor 210.

The impeller 220 can be a rotating impeller used to increase the pressure of a gas. The impeller 220 accelerates the gas radially, which increases its kinetic energy. The kinetic energy is then converted to pressure as the gas passes through a diffuser. The impeller 220 has a series of blades designed to compress the gas from an intake manifold as it flows past the impeller. The compressed gas is then forced into an exhaust manifold, where it can be coupled to other vehicle systems for cooling electric vehicle batteries or other vehicle mechanical or electrical systems. The impeller 220 is enclosed within an impeller housing 225 which contains the impeller wheel and diffusers, which help to further compress the air.

The turbine housing 215 and impeller housing 225 can be integrated into the compressor housing 230. The compressor housing 230 encloses the shaft 240 and the AFBs 250. The AFBs 250 are used to support the rotating shaft 240, allowing it to spin at very high speeds. An AFB is a type of fluid bearing that uses the lift generated by air foils to support a rotating shaft. AFBs typically consist of a rotating inner portion and a stationary housing. The rotating inner portion is typically supported by a series of air foils, which are thin, curved plates that are arranged around the circumference of the shaft. The housing contains a series of air supply holes, which provide pressurized air to the air foils. A thin film of pressurized air is generated between the inner and stationary housings of the AFBs 250 to create an air cushion between the shaft 240 and the compressor housing 230. While the present embodiments are described using AFBs, liquid foil bearings can be used within the scope of the embodiments of the present disclosure.

AFBs 250 typically must be operated at a rotational speed above their LOS for optimal performance and to reduce wear and premature failure. The LOS for an AFB 250 is the speed at which the AFB 250 transitions from boundary lubrication to hydrodynamic lubrication. Boundary lubrication is a type of lubrication in which there is direct contact between the two surfaces, which can lead to friction and wear. Hydrodynamic lubrication is a type of lubrication in which a thin film of fluid separates the two surfaces, which reduces friction and wear. For AFBs 250, the LOS is the speed at which the rotating shaft 240 generates enough lift to float on a thin film of air. Once the LOS is reached, the AFB 250 operates in the hydrodynamic lubrication regime, which results in very low friction and wear. AFBs 250 can operate at speeds below the LOS, but the bearing life will be reduced if the bearing operates at a speed at which the air film is not thick enough to prevent contact between the shaft and the housing.

The LOS for AFBs may vary due to manufacturing variances, operating load, and the lubricant viscosity. During compressor manufacturing, it is important to determine the LOS for AFB equipped compressors to detect bearing quality issues prior to shipment an to establish a minimum rotational speed to ensure that the compressor operates at a rotational speed greater than the LOS to ensure optimal performance and reliability. To determine the LOS of the installed set of AFBs 250, a sensor 260 is physically coupled to the compressor housing 230 after compressor assembly. The sensor 260 can be an accelerometer or inertial measurement unit for sensing accelerations of the compressor housing 230 or can be a microphone for detecting vibrations of the compressor housing 230.

During end of line production testing, the sensor 260 can be physically attached to the compressor housing 230. The sensor 260 can be physically attached with spring clips, magnets, clamps or the like. The electric motor 210, compressor 220, and shaft 240, can then be run up to the system maximum speed and then allowed to coast back down to zero speed with the motor control disabled. During the coast down process, the sensor 260 can collect spectral data and spin rate data. The spectral data is then analyzed to identify a change in spectral signature associated with a transition to AFB foil contact. The AFB foil contact rotational speed can be compared to a pass/fail criteria for the device. The LOS can then be estimated to be greater than the foil contact rotational speed by a predetermined margin greater than the AFB foil contact rotational speed. The testing procedure can then store the LOS in a memory or the like. This LOS can be used as an operational parameter for the device when installed in a larger system or can be used to characterize the device with respect to design tolerances, etc.

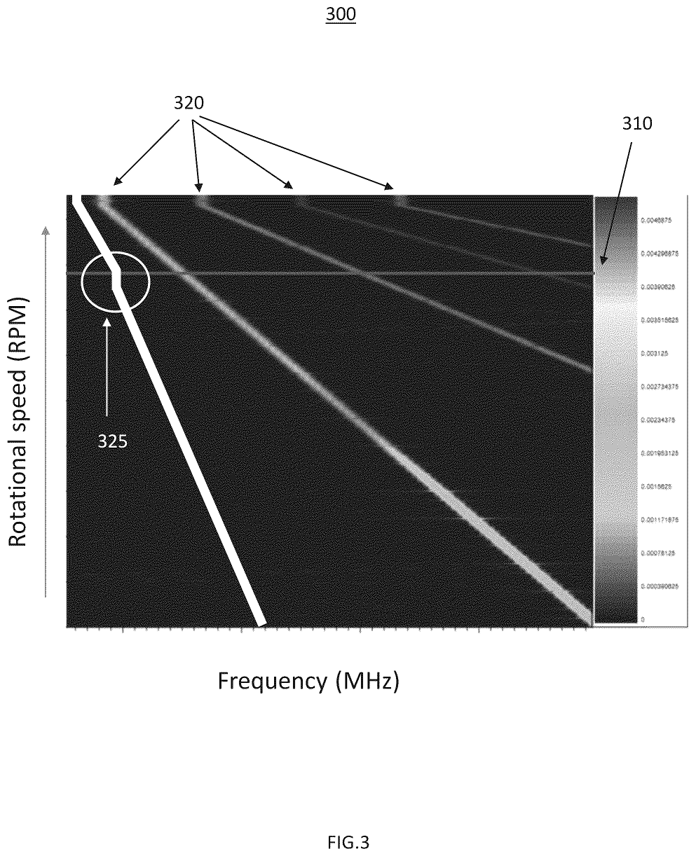

Turning now to FIG. 3, a graph 300 illustrative of an exemplary relationship of frequency versus rotational speed for a compressor during a wind down testing process according to an exemplary embodiments of the present disclosure is shown. The graph 300 illustrates a plurality of rotational speed/frequency relationships 320. While exemplary in nature, these plurality of relationships 320 can be for AFBs of different configurations or for individual AFBs of the same design. An exemplary LOS is indicated by a horizontal line 310.

In some exemplary embodiments, the AFB foil contact rotational speed can be indicated by a step transition or discontinuity 325 in the detected frequency curve. For example, at maximum speed at which the compressor is operating above the LOS, the compressor can emit vibrations at a particular frequency and/or generate microaccelerations at a particular frequency. The compressor is then allowed to coast back down to zero speed with the motor control disabled. During this descent in rotational speed, the frequency of the vibrations or microaccelerations will smoothly decline while the AFB rotational speed is above the LOS. Once the descent of the AFB rotational speed reaches the AFB foil contact rotational speed, the frequency of the vibrations or microaccelerations can experience a discontinuity 325, such as a step function change in frequency or a change in slope of the relationship of frequency versus rotational speed, when the AFB foil contacts the rotational shaft. This discontinuity 325 in the smooth decline of the AFB rotational speed can then be used to determine the AFB foil contact rotational speed and the LOS of the AFB. This LOS can then be stored in a memory for use by a compressor controller or the like during normal operation or can be used to determine if the compressor meets required design criteria or the like.

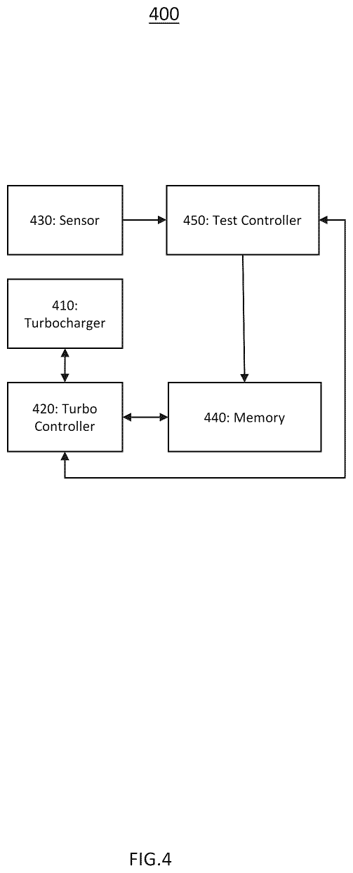

Turning now to FIG. 4, an exemplary system 400 for detecting a LOS in a compressor equipped with an AFB according to an exemplary embodiment of the present disclosure is shown. The exemplary measurement system 400 can include a compressor 410, a turbo controller 420, a sensor 430, a test controller 450 and a memory 440.

In some exemplary embodiments, the compressor 420 is a device under test (DUT) that is tested during or at the end of a manufacturing process. The compressor 420 is equipped with a plurality of AFBs. While a compressor 420 is described as the DUT, the exemplary systems and methods can be utilized for any device employing AFBs to be tested and an LOS can be determined for the device in a similar manner or fashion.

The sensor 430 can be coupled to a housing or case of the compressor 420 such that vibrations of the compressor can be detected. The sensor 430 can be a microphone, accelerometer, inertial measurement unit, or other sensor for detecting a frequency and/or magnitude of an emitted sound or vibration from the compressor 420. In some exemplary embodiments, the sensor 420 can include one or more magnets for physically coupling the sensor 430 to the compressor 420. Alternatively, the sensor 420 can be physically coupled to the compressor 420 using a clamp, clip or other restraint fixture suitable for a manufacturing environment.

The turbo controller 420 is configured to control the rotational speed of the compressor 410 and other operational configurations of the compressor 410. In the case of a compressor driven by an electric motor, the turbo controller 420 can generate control signals or drive currents to power and/or control the electric motor to control the rotational speed of the turbo shaft, impeller and compressor. In some exemplary embodiments, the turbo controller may control a test motor or other device used to rotate the shaft of the compressor 410 to spin the compressor, impeller and shaft such that the shaft is rotated to a maximum operational rotational speed. At this maximum operational rotational speed, the rotational speed of the AFBs should exceed the LOS. The turbo controller 420 can further be configured for coupling an LOS value for the compressor to a memory 440 or the like.

In some exemplary embodiments, the test controller 420 can be a processor, microcontroller having a plurality of inputs and outputs, or a programmable test control device. The test controller 420 is configured to detect or estimate a rotational speed of the compressor shaft and to couple this rotational speed to at least one of the memory 440 or a memory integral to the the test controller 450. The test controller 450 is configured for performing an end of line production testing algorithm to ensure that the compressor 410 meets the required specifications before being shipped to customers. Part of this end of line production testing algorithm can include detecting a LOS for the compressor AFBs and confirming this LOS is within the required specification.

In some exemplary embodiments, the test controller 420 can transmit a control signal to the turbo controller 420 to request that the compressor 410 be spun up to a maximum operational rotational speed. The turbo controller 420 can control the compressor 410 such that the compressor 410 is spun up to a maximum operational rotational speed. The turbo controller 420 can then transmit a confirmation back to the test controller 450 that the compressor 410 has been spun up to a maximum operational rotational speed. The confirmation can include a current rotational speed of the compressor 410 as determined by the turbo controller 420. The test controller 420 can then request and receive a data indicative of a frequency of a vibration of the compressor 410 from the sensor 430. The test controller 450 can next request that the turbo controller 420 disengage the motor driving the compressor 410 such that the compressor 410 is allowed to coast back down to zero rotational speed. During this coast down period, the test controller 450 can request and receive rotational speeds of the compressor 410 from the turbo controller 420, a rotational sensor or the like. The test controller 450 can also receive frequency data from the sensor 430 at times corresponding to the rotational speeds of the compressor 410. This frequency data can be correlated with the rotational speed based on the time of measurement and stored in a memory 440. The test controller 450 can repeat this process periodically through the coast down period until the compressor 410 stops rotating to generate a plurality of rotational speed/frequency pairs.

Once the rotation of the compressor 410 stops and the plurality of rotational speed/frequency pairs are compiled into a data file and stored in the memory 440, the test controller 450 can then examine complied rotational speed/frequency pairs to determine at which frequency the compressor 410 reached the AFB foil contact rotational speed. The AFB foil contact rotational speed may be determined in response to a known frequency for AFB foil contact, or may be determined in response to a discontinuity in the frequency/speed relationship. For example, during the bearing lift off portion of the coast down period, the frequency may smoothly decrease as the rotational speed decreases. Once the AFB foil contact event occurs, the frequency may abruptly change and/or the change in rotational speed and/or frequency can being to decline at a faster rate due to the increased friction. During the AFB foil contact portion of the coast down period, the frequency can again decrease smoothly until the compressor 410 stops rotating.

In response to the detected AFB foil contact rotational speed, the test controller 450 can then determine the LOS for the compressor 410. This LOS can be determined in response to the AFB foil contact rotational speed plus a margin value, such as ten revolution per minute. The LOS can be set to the AFB foil contact rotational speed. During operation of the compressor 410, a vehicle control system or vehicle compressor controller can use this LOS to establish a minimum rotational speed for the compressor 410 to reduce wear and ensure optimal performance. This LOS value can be stored in a memory, electronic data storage device or documentation associated with the compressor 410 when shipped to the customer. The LOS value can then be entered into a turbo controller for control of the compressor.

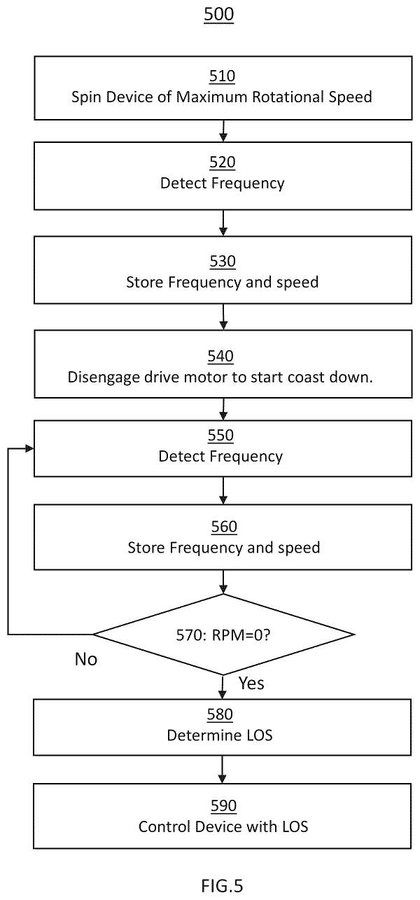

Turning now to FIG. 5, an exemplary method 500 for controlling a system for detecting a LOS in a device equipped with an AFB according to an exemplary embodiment of the present disclosure is shown. In some exemplary embodiments, the device can include high-speed turbomachinery devices, such as compressors, blowers, turbines, and compressors, high-speed electric motors and generators, precision equipment, such as machine tools, gyroscopes, and aerospace systems., or medical devices, such as dental drills and surgical robots.

The method is first configured for spinning 510 the device to a maximum rotational speed. The compressor can be spun to the maximum rotational speed by an integrated electric motor, such as in the case of an electric motor assisted compressor, or by an external drive device, such as an electric motor or other rotational drive device. Once the device has reached the maximum rotational speed, the AFBs should be operating at a rotational speed above the LOS.

The method is next operative to detect 520 a frequency of a vibration emitted by the device in response to the rotational operation. The frequency can be detected using a microphone, accelerometer, internal measurement unit or other vibration detecting device physically coupled to the housing of the device. In some exemplary embodiments, a microphone can be used to detect a sound wave emanating from the device which can then be used to determine the frequency of the sound. In some exemplary embodiments, an antenna can be used to detect an electromagnetic signal emanating from the device, and the resulting signal from the antenna can then be used to determine the frequency of the electromagnetic signal.

In response to detecting the frequency, the method is next operative to store the frequency and the corresponding rotational speed in a memory or the like. The rotational speed can be received from the device or can be detected using a rotational speed sensor or the like. After storing the initial frequency and rotational speed corresponding to the maximum rotational speed, the method is next operative to disengage the drive motor to start a coast down operation of the device where the device rotational speed is allowed to drop from the maximum rotational speed to a full stop or zero rotational speed.

During the coast down operation, the method continues to detect 550 the frequency of vibrations emitted by the device and to store 560 this frequency with the corresponding rotational speed in a data file in a memory or the like with any prior detected frequencies and speeds. After storing the rotational speed and frequency, the method next determines 570 if the rotational speed of the device has reached zero revolutions per minute. If the device has not reached zero revolutions per minute, the method returns to detecting 550 a subsequent frequency.

If the device has reached zero revolutions per minute, the method then determines 580 an LOS for the device. The LOS can be determined in response to a discontinuity in the frequency/rotational speed curve or a change in the slope of the frequency/rotational speed curve. In some exemplary embodiments, the LOS is indicative of the speed at which the air foil bearing transitions from boundary lubrication to hydrodynamic lubrication. This transition is characterized by a sharp decrease in friction and an increase in load capacity. The LOS rotational speed value is then stored in a memory communicatively coupled to a device controller or the like. In some exemplary embodiments, a test processor or the like can continuously monitor the frequency/rotational speed pairs and detect the LOS before the device has reached zero revolutions per minute. Once the test processor has detected the LOS, the LOS value can be stored in a memory and the LOS detection algorithm can be stopped.

In some exemplary embodiments, the LOS value can be used for sorting in a manufacturing environment, such as in a manufacturing test environment, control 590 of the device may include rework or remanufacture. For example, if the LOS is greater than a predetermined limit, the compressor can be flagged for rework or remanufacture with alternate AFBs. A maximum LOS value could be defined and any device having an LOS exceeding that value could be rejected or designated for rework. Alternatively, devices with differing LOS values could be sorted for use in different applications having different operating rotational speed or different reliability requirements. The LOS value could also be used to monitor the quality of the components with time, which means the LOS value would be recorded and stored for further analysis.

After installation of the device into an application, such as a compressor into a vehicle, the LOS rotational speed value can then be used to control 590 the device. For example, the LOS can be used as a minimum rotational speed during operations. In the example of a compressor, an electric motor assist can be used to accelerate and maintain the compressor rotational speed above the LOS during operation to reduce wear and increase efficiency.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It is understood that various changes may be made in the function and arrangement of elements described in an exemplary embodiment without departing from the scope of the present disclosure as set forth in the appended claims.

What is claimed is:

1. An apparatus comprising:
a device having a rotational shaft supported by a plurality of air foil bearings;
a sensor for detecting a magnitude and a frequency of a signal emitted by the device during rotation of the rotational shaft;
a controller for detecting a lift off speed of the plurality of air foil bearings in response to the frequency of the signal; and
a memory for storing the lift off speed, wherein the memory is communicatively coupled to a device controller for controlling a rotational speed of the rotational shaft in response to the lift off speed.

2. The apparatus of claim 1 wherein the device is a compressor.

3. The apparatus of claim 1 further including a drive motor for rotating the rotational shaft in response to a first control signal from the controller.

4. The apparatus of claim 1 where the device is a compressor and wherein the device controller limits the rotational speed of the rotational shaft to a rotational speed greater than the lift off speed.

5. The apparatus of claim 1 wherein the controller is further configured for generating a first control signal to control the device to spin at a predetermined operational rotational speed and wherein the detection of the lift off speed is made in response to a sudden change in the frequency of the signal emitted by the device during that first period of time.

6. The apparatus of claim 1 wherein the device controller is configured to maintain the rotational speed of the rotational shaft above the lift off speed during an operation of the device.

7. The apparatus of claim 1 wherein the sensor is at least one of an accelerometer and a displacement sensor.

8. The apparatus of claim 1 further including detecting a rotational speed of the rotational shaft and wherein the rotational speed is used to determine the lift off speed.

9. The apparatus of claim 1 wherein the frequency of a signal is stored in a memory with a corresponding rotational speed of the rotational shaft.

10. The apparatus of claim 1 wherein the device is a compressor equipped with an electric motor and wherein the electric motor is operative to maintain an operational rotational speed of the rotational shaft greater than the lift off speed.

11. A method for determining a lift off speed of an air foil bearing comprising:
controlling a device having a rotational shaft supported by a plurality of air foil bearings to rotate at a predetermined operational rotational speed;
disengaging a drive source coupled to the rotational shaft such that the rotational shaft such that the begins a rotational speed coast down phase from the maximum operational rotational speed to a zero rotational speed;
detecting, by a sensor, at least one of a frequency and a magnitude of a vibration of the device and a rotational speed of the rotational shaft at a plurality of times within the coast down phase;
determining, by a test controller, a lift off speed of the air foil bearing in response to the plurality of frequencies; and
storing the lift off speed in a memory communicatively coupled to the device.

12. The method for determining a lift off speed of an air foil bearing of claim 11 wherein the device is a compressor.

13. The method for determining a lift off speed of an air foil bearing of claim 11 wherein the lift off speed is determine in response to a change in the frequency of the vibration resulting from an air foil bearing foil contact event.

14. The method for determining a lift off speed of an air foil bearing of claim 11 wherein the lift off speed is determine in response to a change in the frequency of the vibration resulting from an air foil bearing foil contact event.

15. The method for determining a lift off speed of an air foil bearing of claim 11 wherein the lift off speed is determine in response to a change in a slope of a ratio of a plurality of detected frequencies at a plurality of associated rotational speeds.

16. The method for determining a lift off speed of an air foil bearing of claim 11 wherein the device is a compressor driven by an electric motor and wherein a compressor controller controls the rotational speed of the electric motor in response to the life off speed such that the compressor operates at an operating rotational speed greater than the lift off speed.

17. The method for determining a lift off speed of an air foil bearing of claim 11 wherein the method is performed during an end of line testing operation.

18. The method for determining a lift off speed of an air foil bearing of claim 11 wherein the sensor is an accelerometer.

19. A compressor test system comprising:
a rotational sensor for measuring a rotational speed of a compressor shaft supported by an air foil bearing;
a sensor for measuring at least one of a frequency and a magnitude of a vibration generated in response to a rotation of the compressor shaft;
a controller for determining a lift off speed of the air foil bearing in response to the frequency of the vibration and the rotational speed measured at a plurality of times during a transition of the rotational speed between a first rotational speed and a second rotational speed; and
a compressor controller for controlling an operation of the compressor such that an operating rotational speed of the compressor shaft is greater than the lift off speed.

20. The compressor test system of claim 19 further including a data interface for storing a data including the lift off speed in a memory accessible by the compressor.
